(19) United States
(12) Patent Application Publication
(10) Pub. No.: US 2009/0274029 A1
(43) Pub. Date: Nov. 5, 2009

(54) OPTICAL PICKUP AND INFORMATION DEVICE

(76) Inventors: Masataka Izawa, Saitama (JP); Takehisa Okuyama, Saitama (JP); Naoharu Yanagawa, Saitama (JP)

Correspondence Address: NIXON & VANDERHYE, PC, 901 NORTH GLEBE ROAD, 11TH FLOOR, ARLINGTON, VA, 22203, US

(21) Appl. No.: 12/295,067

(22) PCT Filed: Mar. 29, 2007
(86) PCT No.: PCT/JP2007/056930

§ 371 Date: Feb. 3, 2009

(30) Foreign Application Priority Data
Mar. 30, 2006 (JP) 2006-095492

(51) Int. Cl. G11B 3/74; G11B 7/24

(52) U.S. Cl. 369/94; 369/275.4; G9B/3.108; G9B/7.139

(57) ABSTRACT

An optical pickup (100) includes: (i) a light source (101) for emitting a laser beam; (ii) an optical system (105, etc.) for introducing the laser beam into one of recording layers; (iii) an optical function element (104) for changing a predetermined polarized state in the laser beam in the unit of micro regions contained in the region where the laser beam is applied for each of the micro region positions; and (iv) light receiving means (PD0, etc.) for receiving at least the laser beam.

### TECHNICAL FIELD

The present invention relates to an optical pickup for irradiating an information recording medium, such as a DVD, with a laser beam when an information signal is recorded or reproduced, and information equipment provided with the optical pickup.

### BACKGROUND ART

For example, there has been developed an information recording medium, such as a multilayer type optical disc, for optically recording or reproducing an information signal (data) using a laser beam or the like, such as a dual-layer type DVD, a dual-layer type Blu-ray, and a dual-layer type HD-DVD. In such a multilayer type optical disc, if the interval between recording layers is large, a signal from the selected recording layer possibly deteriorates due to an influence of spherical aberration, so that the interval between recording layers tends to be narrowed. However, if the interval between recording layers is narrowed, because of so-called interlayer crosstalk, return light from the multilayer type optical disc includes not only a component of reflected light (hereinafter referred to as “signal light” as occasion demands) generated in a selected desired recording layer (hereinafter referred to as “one recording layer” as occasion demands) but also a component of reflected light (hereinafter referred to “stray light” as occasion demands) generated in another recording layer other than the one recording layer, at high level. Thus, an S/N ratio of the signal component of a reproduction signal or the like is possibly reduced, which possibly makes it hard to properly perform various controls, such as tracking control. Specifically, in general, it is known that a signal component of the signal light and a component of stray light have a relationship of tradeoff on the multilayer type optical disc. That is, if a light receiving area of a light receiving device is reduced, it is possible to make the component of the stray light at a relatively low level and to reduce an influence of the stray light; however, at the same time, the signal component of the signal light also becomes at a relatively low level, and the S/N ratio is reduced, which makes it hard to properly perform the various controls, such as tracking control. On the other hand, if the light receiving area is increased, it is possible to make the signal component of the signal light at a relatively high level; however, at the same time, the component of the stray light also becomes at a relatively high level, and the S/N ratio is reduced, which makes it hard to properly perform the various controls, such as tracking control.

Thus, for example, in a tracking method in the recording or reproduction of the dual-layer type Blu-ray Disc, there has been suggested a technology of avoiding the stray light entering the light receiving element, by separating a push-pull signal from the signal light, using a hologram element. Alternatively, a patent document 1 discloses a technology of separating the reflected light from each recording layer, highly accurately, using a difference in angle of the optical axis of the return light returning from each recording layer of the dual-layer type optical disc.

Patent document 1: Japanese Patent Application Laid Open NO. 2005-228436

### DISCLOSURE OF INVENTION

### Subject to be Solved by the Invention

However, in the various methods for reducing the influence of the stray light described above, as shown in FIG. 13, the stray light enters the light receiving element for receiving a focus error signal or RF signal (refer to overlap between “Stray light” and “Transmitted beam” in FIG. 13), so that there is such a technical problem that the S/N ratio of the signal component of the return light returning from the desired recording layer is reduced due to the influence of the stray light.

Alternatively, according to the patent document 1 described above or the like, there is such a technical problem that it is hard to manage or control various aberrations. Alternatively, there is such a technical problem that it is necessary to optimize the position of a Z-axis direction of a condenser lens for condensing the return light, or a light receiver, when the recording layer is changed.

In view or the aforementioned problems, it is therefore an object of the present invention to provide an optical pickup which can reproduce or record an information signal with higher accuracy, while reducing an influence of stray light, in an information recording medium, such as a multilayer type optical disc, and information equipment provided with such an optical pickup.

### Means for Solving the Subject

(Optical Pickup)

The above object of the present invention can be achieved by an optical pickup for recording or reproducing an information signal with respect to an optical disc provided with a plurality of recording layers, each recording layer having a recording track in which information pits are arranged, the information signal being recorded in the information pits, the optical pickup provided with: a light source for irradiating a laser beam; an optical system (e.g. optical path branching element, condenser lens) for guiding the laser beam to one recording layer of the plurality of recording layers; an optical functional element for changing a predetermined polarization state of the laser beam, by a unit of micro domain included in an area irradiated with the laser beam, in each position of the micro domain; and one or a plurality of light receiving devices (e.g. PD0/PD1a/PD1b) for receiving at least the laser beam.

According to the optical pickup of the present invention, the laser beam irradiated from the light source, is guided to and focused on the one recording layer of the plurality of recording layers by the optical system, such as an objective lens, a beam splitter, or a prism. At the same time, one return light generated in the one recording layer, is received by the light receiving device. Thus, the laser beam guided to and focused on the one recording layer, allows the information pits or marks formed in the one recording layer to be reproduced. Thus, it is possible to reproduce predetermined information from the optical disc. Alternatively, the focused laser beam allows the information pits or marks to be formed in the one recording layer. Thus, it is possible to record predetermined information onto the optical disc.

In particular, according to the present invention, the optical functional element can change the predetermined polarization state, for example, having a constant polarization direction, of the laser beam, such as zero-order light or zero-order ray, which is transmitted through the optical functional element, by the unit of micro domain included in the area irradiated with the laser beam, in each position of the micro domain. Here, the “micro domain” means a predetermined area of the optical functional element in order to differentiate the extent of changing the predetermined polarization state of the laser beam, in each position.

As a result, on the light receiving devices, it is possible to effectively reduce an influence of the light interference between the stray light of the zero-order light (or the zero-order ray) and the signal lights of the ±first-order diffraction lights (or ±first-order diffraction rays), whose irradiation areas overlap, for example. In particular, after the lights are transmitted through the optical functional element, the predetermined polarization state in the signal light of the zero-order light and the stray lights of the ±first-order diffraction lights, are changed by the unit of micro domain included in the irradiation area of the optical functional element, which is irradiated with the laser beam, in each position of the micro domain. Thus, it is possible to reduce the influence of the light interference by the stray light, on the light receiving device which receives the zero-order light.

As a result, it is possible to make the light receiving device receive the light, under the condition that the influence of the stray light is effectively reduced and the level of the light intensity is maintained to be higher, for example, in the tracking control and focus control based on a three-beam method on the multilayer type information recording medium, to thereby achieve the highly-accurate tracking control.

In one aspect of the optical pickup of the present invention, the unit of micro domain is defined on the basis of magnitude of a constituent unit of a refractive index anisotropic medium, which constitutes the optical functional element.

According to this aspect, the predetermined polarization state in the signal light of the zero-order light and the stray lights of the ±first-order diffraction lights can be changed, appropriately and highly accurately, by the unit of micro domain in each position of the micro domain, after the lights are transmitted through the micro domain defined on the basis of the magnitude of the constituent unit of the refractive index anisotropic medium. Thus, it is possible to more appropriately reduce the influence of the light interference by the stray light on the light receiving device which receives the zero-order light.

In another aspect of the optical pickup of the present invention, the unit of micro domain is defined on the basis of magnitude of liquid crystal molecules, which constitute the optical functional element.

According to this aspect, the predetermined polarization state in the signal light of the zero-order light and the stray lights of the ±first-order diffraction lights can be changed, appropriately and highly accurately, by the unit of micro domain in each position of the micro domain, after the lights are transmitted through the micro domain defined on the basis of the magnitude of the liquid crystal molecules. Thus, it is possible to more appropriately reduce the influence of the light interference by the stray light on the light receiving device which receives the zero-order light.

In another aspect of the optical pickup of the present invention, the unit of micro domain is defined on the basis of magnitude of an assembly of liquid crystal molecules defined by a difference in a process of rubbing an oriented film, which constitutes the optical functional element.

According to this aspect, the predetermined polarization state in the signal light of the zero-order light and the stray lights of the ±first-order diffraction lights can be changed, appropriately and highly accurately, by the unit of micro domain in each position of the micro domain, after the lights are transmitted through the micro domain defined on the basis of the magnitude of the assembly of liquid crystal molecules defined by the difference in the process of rubbing the oriented film. Thus, it is possible to more appropriately reduce the influence of the light interference by the stray light on the light receiving device which receives the zero-order light.

In another aspect of the optical pickup of the present invention, the optical functional element is provided with: (i) a first substrate; (ii) a second substrate; and (iii) a refractive index anisotropic medium enclosed between the first substrate and the second substrate.

According to this aspect, it is possible to highly accurately differentiate the degree of changing the predetermined polarization state by the unit of micro domain of the optical functional element in each position of the micro domain, on the basis of the optical functional element which is provided with the first substrate, the second substrate, and the refractive index anisotropic medium. Here, the “refractive index anisotropic medium” in the present invention means a medium with anisotropy in an optical refractive index.

In another aspect of the optical pickup of the present invention, the optical functional element is provided with: (i) a first substrate; (ii) a second substrate; and (iii) a refractive index anisotropic medium enclosed between the first substrate and the second substrate and arranged irregularly in at least one of a thickness direction and a plane direction.

According to this aspect, it is possible change the predetermined polarization state of the laser beam, by the unit of micro domain of the optical functional element in each position of the micro domain, after the laser beam is transmitted through the optical functional element which is provided with the liquid crystal molecules irregularly arranged in at least one of the thickness direction and the plane direction.

In another aspect of the optical pickup of the present invention, the optical functional element is disposed on an optical path which is a parallel light flux.

According to this aspect, it is possible change the predetermined polarization state of the laser beam, with the loss in the amount of light being more reduced, by the unit of micro domain of the optical functional element in each position of the micro domain, after the laser beam is transmitted through the optical functional element which is disposed on the optical path as the parallel light flux.

In another aspect of the optical pickup of the present invention, it is further provided with an optical path branching device for guiding the laser beam coming from the one recording layer, to the light receiving device.

According to this aspect, it is possible to change the predetermined polarization state of the laser beam, with the loss in the amount of light being more reduced, by the unit of micro domain of the optical functional element in each position of the micro domain, after the laser beam is transmitted through the optical functional element, on the basis of the relative positional relationship between the optical functional element and the optical path branching device.

In another aspect of the optical pickup of the present invention, it is further provided with a diffracting device (diffraction grating) for diffracting the irradiated laser beam to zero-order light and diffraction light (±first-order diffraction lights), the optical system guiding the zero-order light and the diffraction light, which are diffracted, to the one recording layer, the optical functional element (i) differentiating a polarization state in one portion of the zero-order light on the basis of all positions of the zero-order light and (ii) differentiating a polarization state in one portion of the diffraction light on the basis of all positions of the diffraction light, the light receiving device receiving at least the diffraction light.

According to this aspect, the optical functional element can change the predetermined polarization state, for example, having a constant polarization direction of the zero-order light and the diffraction light, which are transmitted through the optical functional element and which are diffracted, by the unit of micro domain of the optical functional element, in each position of the micro domain. In particular, since the stray light of the zero-order light and the signal light of the diffraction light have substantially the same level of light intensity, it is possible to more significantly reduce the influence of the light interference by the stray light on the light receiving device which receives the diffraction light, by changing respectively the polarization states of the both the stray light of the zero-order light and the signal light of the diffraction light by the unit of micro domain of the optical functional element in each position of the micro domain.

As a result, it is possible to make the light receiving device receive the light, under the condition that the influence of the stray light is effectively reduced and the level of the light intensity is maintained to be higher, for example, in the tracking control based on the three-beam method on the multilayer type information recording medium, to thereby achieve the highly-accurate tracking control.

In an aspect associated with the optical functional element described above, it may be further provided with an optical path branching device for guiding the zero-order light and the diffraction light coming from the one recording layer, to the light receiving device, the optical functional element being disposed (i) on an optical path between the light source and the optical path branching device or (ii) on an optical path between the optical path branching device and the light receiving device.

By virtue of such construction, it is possible to change the predetermined polarization state of the laser beam, with the loss in the amount of light being more efficiently reduced, by the unit of micro domain of the optical functional element in each position of the micro domain, after the laser beam is transmitted through the optical functional element, on the basis of the relative positional relationship between (i) the optical functional element and (ii-1) the optical path between the light source and the optical path branching device or (ii-2) the optical path between the optical path branching device and the light receiving device.

In an aspect associated with the optical functional element described above, it may be further provided with an optical path branching device for guiding the zero-order light and the diffraction light coming from the one recording layer, to the light receiving device, the optical functional element being disposed (i) on an optical path, which is a parallel light flux, between the light source and the optical path branching device or (ii) on an optical path, which is a parallel light flux, between the optical path branching device and the light receiving device.

By virtue of such construction, it is possible to change the predetermined polarization state of the laser beam, with the loss in the amount of light being more efficiently reduced, by the unit of micro domain of the optical functional element in each position of the micro domain, after the laser beam is transmitted through the optical functional element, on the basis of the relative positional relationship between (i) the optical functional element and (ii-1) the optical path, which is the parallel light flux, between the light source and the optical path branching device or (ii-2) the optical path, which is the parallel light flux, between the optical path branching device and the light receiving device.

In an aspect associated with the optical functional element described above, order of the diffraction light may be ±first-order.

According to this aspect, by virtue of the optical functional element, it is possible to change the predetermined polarization state of the zero-order light and the predetermined polarization state of the diffraction light, which are transmitted through the optical functional element, by the unit of micro domain of the optical functional element, in each position of the micro domain.

In another aspect of the optical pickup of the present invention, it is provided with (i) a first light receiving device and (ii) a second light receiving device, which receive diffraction light of the laser beam, and (iii) a third light receiving device, which receives zero-order light of the laser beam, as the light receiving devices.

According to this aspect, it is possible to make the light receiving device receive the light, under the condition that the influence of the stray light is effectively reduced and the level of the light intensity is maintained to be higher, for example, in the tracking control based on the three-beam method on the multilayer type information recording medium, to thereby achieve the highly-accurate tracking control.

In another aspect of the optical pickup of the present invention, it is further provided with a controlling device (tracking control/focus control) for controlling the optical system to guide the laser beam to the recording track provided for the one recording layer, on the basis of zero-order light and diffraction light of the laser beam.

According to this aspect, it is possible to make the light receiving device receive the light, under the condition that the influence of the stray light is effectively reduced and the level of the light intensity is maintained to be higher, for example, on the multilayer type information recording medium, to thereby achieve the highly-accurate focus control and tracking control.

(Information Equipment)

The above object of the present invention can be also achieved by an information equipment provided with: the optical pickup of the present invention described above; and a recording/reproducing device for irradiating the optical disc with the laser beam, to thereby record or reproduce the information signal.

According to the information equipment of the present invention, it is possible to record the information signal onto the optical disc or to reproduce the information signal recorded on the optical disc, while receiving the same various benefits as those of the optical pickup of the present invention described above.

These effects and other advantages of the present invention will become more apparent from the embodiments explained below.

As explained above, according to the optical pickup of the present invention, it is provided with the light source, the optical system, the optical functional element, and the light receiving device. Therefore, it is possible to make the light receiving device receive the light, under the condition that the influence of the stray light is relatively reduced and the level of the light intensity is maintained to be higher, for example, in the tracking control and focus control on the multilayer type information recording medium, to thereby achieve the highly-accurate tracking control focus control.

Alternatively, according to the information equipment of the present invention, it is provided with the light source, the optical system, the optical functional element, the light receiving device, and the recording/reproducing device. Therefore, it is possible to make the light receiving device receive the light, under the condition that the influence of the stray light is relatively reduced and the level of the light intensity is maintained to be higher, for example, in the tracking control and focus control on the multilayer type information recording medium, to thereby achieve the highly-accurate tracking control focus control.

### BRIEF DESCRIPTION OF DRAWINGS

FIG. 1 is a block diagram showing the basic structure of an information recording/reproducing apparatus in an embodiment of the information recording apparatus of the present invention and a host computer.

FIG. 2 is a block diagram conceptually showing the more detailed structure of an optical pickup 100 provided for an information recording/reproducing apparatus 300 in the embodiment.

FIG. 3 is a cross sectional view conceptually showing an optical principle of an optical functional element 104 in the embodiment, with a focus on an X-axis direction and a Z-axis direction.

FIG. 4 is a cross sectional view schematically showing the optical placement of the optical functional element in the embodiment and the polarization state of a light flux of a laser beam before and after being transmitted through the optical functional element.

FIG. 5 is a table showing a pattern of the polarization state in the embodiment.

FIG. 6 is a plan view conceptually showing a relative positional relationship among optical diameters of the zero-order light and the ±first-order diffraction lights irradiated on three light receiving devices in the embodiment.

FIG. 7 is a plan view conceptually showing a relative positional relationship among optical diameters of the zero-order light and the ±first-order diffraction lights irradiated on three light receiving devices in a comparison example.

FIG. 8 is a schematic diagram conceptually showing a positional relationship among (i) a first substrate, (ii) liquid crystal molecules, and (iii) a second substrate, which constitute the optical functional element 104 in the embodiment.

FIG. 9 is a schematic diagram conceptually showing an optically anisotropic medium (i.e. refractive index anisotropic medium) which constitutes the optical functional element 104 in the embodiment.

FIG. 10 are a schematic diagram conceptually showing a general optically isotropic nature (FIG. 10(a)) and a schematic diagram conceptually showing general optical anisotropy (FIG. 10(b)).

FIG. 11 is a schematic diagram conceptually showing a positional relationship among (i) a first substrate, (ii) liquid crystal molecules, and (iii) a second substrate, which constitute the optical functional element 104 in the embodiment.

FIG. 12 is a block diagram conceptually showing the more detailed structure of an optical pickup 100 provided for an information recording/reproducing apparatus 300 in another embodiment.

FIG. 13 is a plan view showing a relative positional relationship between a light receiving device and an optical diameter in a comparison example.

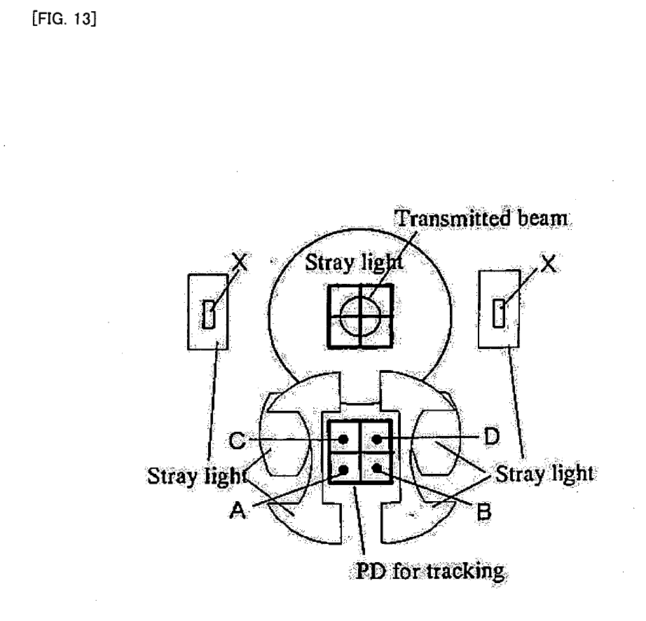

### DESCRIPTION OF REFERENCE CODES

10 optical disc

100 optical pickup

101 semiconductor laser

102 diffraction grating

103 etc. collimator lens or condenser lens

104 optical functional element

105 optical path branch element

106 reflection mirror

107 ¼ wave retarder plate or ¼ wavelength plate

110 astigmatism generating lens

PD0 etc. light receiving device

300 information recording/reproducing apparatus

302 signal recording/reproducing device

### BEST MODE FOR CARRYING OUT THE INVENTION

Hereinafter, the best mode for carrying out the invention will be explained in each embodiment in order, with reference to the drawings.

(1) Embodiment of Information Recording/Reproducing Apparatus

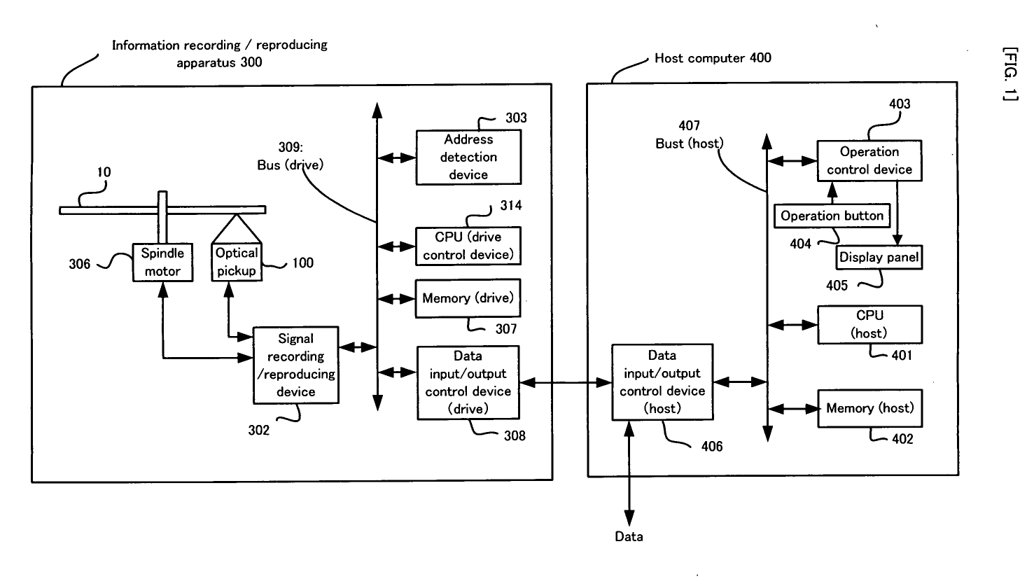

Firstly with reference to FIG. 1, a detailed explanation will be given on the structure and operation of an embodiment of the information recording apparatus of the present invention. In particular, in the embodiment, the information recording apparatus of the present invention is applied to an information recording/reproducing apparatus for an optical disc.

(1-1) Basic Structure

Firstly, with reference to FIG. 1, an explanation will be given on the basic structure of an information recording/reproducing apparatus 300 in an embodiment of the information recording apparatus of the present invention and a host computer 400. FIG. 1 is a block diagram showing the basic structure of the information recording/reproducing apparatus in the embodiment of the information recording apparatus of the present invention and the host computer. Incidentally, the information recording/reproducing apparatus 300 has a function of recording record data onto an optical disc 10 and a function of reproducing the record data recorded on the optical disc 10.

As shown in FIG. 1, the inner structure of the information recording/reproducing apparatus 300 will be explained. The information recording/reproducing apparatus 300 is an apparatus for recording information onto the optical disc 10 and for reading the information recorded on the optical disc 10, under the control of a CPU (Central Processing Unit) 314 for drive.

The information recording/reproducing apparatus 300 is provided with: the optical disc 10; an optical pickup 100; a signal recording/reproducing device 302; an address detection device 303; the CPU (drive control device) 314; a spindle motor 306; a memory 307; a data input/output control device 308; and a bus 309.

Moreover, the host computer 400 is provided with: a CPU (host control device) 401; a memory 402; an operation control device 403; an operation button 404; a display panel 405; a data input/output control device 406; and a bus 407.

In particular, the information recording/reproducing apparatus 300 may be constructed to communicate with an external network by housing the host computer 400 equipped with a communication device, such as a modem, in the same case. Alternatively, the information recording/reproducing apparatus 300 may be constructed to communicate with an external network by that the CPU (host control device) 401 of the host compute 400 equipped with a communication device, such as an i-link, controls the information recording/reproducing apparatus 300 directly through the data input/output control device 308 and the bus 309.

The optical pickup 100 is to perform the recording/reproducing with respect to the optical disc 10, and is provided with a semiconductor laser apparatus and a lens. More specifically, the optical pickup 100 irradiates the optical disc 10 with a light beam, such a laser beam, as reading light with a first power upon reproduction, and as writing light with a second power with it modulated upon recording.

The signal recording/reproducing device 302 performs the recording/reproducing with respect to the optical disc 10 by controlling the optical pickup 100 and the spindle motor 306. More specifically, the signal recording/reproducing device 302 is provided with a laser diode driver (LD driver), a head amplifier, and the like. The LD driver drives the not-illustrated semiconductor laser built in the optical pickup 100. The head amplifier amplifies the output signal of the optical pickup 100, i.e., the reflected light of the laser beam, and outputs the amplified signal. More specifically, the signal recording/reproducing device 302 drives the not-illustrated semiconductor laser built in the optical pickup 100 so as to determine an optimum laser power by the processes of recording and reproducing an OPC pattern, together with a not-illustrated timing generator or the like, under the control of the CPU 314, in an OPC (Optimum Power Control) process. In particular, the signal recording/reproducing device 302 constitutes one example of the “recording/reproducing device” of the present invention, with the optical pickup 100.

The address detector 303 detects an address (address information) on the optical disc 10 from a reproduction signal including e.g. a pre-format address signal or the like, outputted by the signal recording/reproducing device 302.

The CPU (drive control device) 314 controls the entire information recording/reproducing apparatus 300 by giving instructions to various devices, through the buss 309. Incidentally, software or firmware for operating the CPU 314 is stored in the memory 30. In particular, the CPU 314 constitutes one example of the “controlling device” of the present invention.

The spindle motor 306 is to rotate and stop the optical disc 10, and operates in accessing the optical disc 10. More specifically, the spindle motor 306 is constructed to rotate the optical disc 10 at a predetermined speed and stop it, under the spindle servo provided by a not-illustrated servo unit or the like.

The memory 307 is used in the general data processing and the OPC process on information recording/reproducing apparatus 300, including a buffer area for the record/reproduction data, an area used as an intermediate buffer when data is converted into the data that can be used on the signal recording/reproducing device 302, and the like. Moreover, the memory 307 is provided with: a ROM area in which a program for performing an operation as a recording device, i.e., firmware, is stored; a buffer for temporarily storing the record/reproduction data; a RAM area in which a parameter required for the operation of the firmware program or the like is stored; and the like.

The data input/output control device 308 controls the data input/output from the exterior with respect to the information recording/reproducing apparatus 300, and stores the data into or extracts it from a data buffer on the memory 307. A drive control command, which is issued from the external host computer 400 connected to the information recording/reproducing apparatus 300 via an interface, such as a SCSI (Small Computer System Interface) and an ATAPI (AT Attachment Packet Interface), is transmitted to the CPU 314 through the data input/output control device 308. Moreover, the record/reproduction data is also exchanged with the host computer 400 through the data input/output control device 308.

The CPU (host control device) 401, the memory 402, the data input/output control device 406, and the bus 407 of the host computer 400 are substantially the same as the corresponding constituent elements in the information recording/reproducing apparatus 300.

The operation control device 403 performs the reception of the operation instruction and display with respect to the host computer 400. The operation control device 403 sends the instruction to perform the recording or reproduction, using the operation bottom 401, to the CPU 401. The CPU 401 may send a control command to the information recording/reproducing apparatus 300 through the input/output control device 406 on the basis of the instruction information from the operation/display control device 403, to thereby control the entire information recording/reproducing apparatus 300. In the same manner, the CPU 401 can send a command of requiring the information recording/reproducing apparatus 300 to send the operational state to the host, to the information recording/reproducing apparatus 300. By this, it is possible to recognize the operational state of the information recording/reproducing apparatus 300, such as during recording and during reproduction. Thus, the CPU 401 can output the operational state of the information recording/reproducing apparatus 300, to the display panel 405, such as a fluorescent tube and a LCD, through the operation control device 403.

One specific example in which the information recording/reproducing apparatus 300 and the host computer 400, as explained above, are used together is household equipment, such as recorder equipment for recording/reproducing a video. The recorder equipment is equipment for recording a video signal from a broadcast reception tuner and an external connection terminal, onto a disc, and for outputting the video signal reproduced from the disc, to external display equipment, such as a television. The operation as the recorder equipment is performed by executing a program stored in the memory 402, on the CPU 401. Moreover, in another specific example, the information recording/reproducing apparatus 300 is a disc drive (hereinafter referred to as a drive, as occasion demands), and the host computer 400 is a personal computer or a workstation. The host computer 400, such as the personal computer, and the disc drive are connected to each other through the data input/output control devices 308 and 406, such as the SCSI and the ATAPI. An application, such as writing software, which is installed in the host computer, controls the disc drive.

(2) Optical Pickup

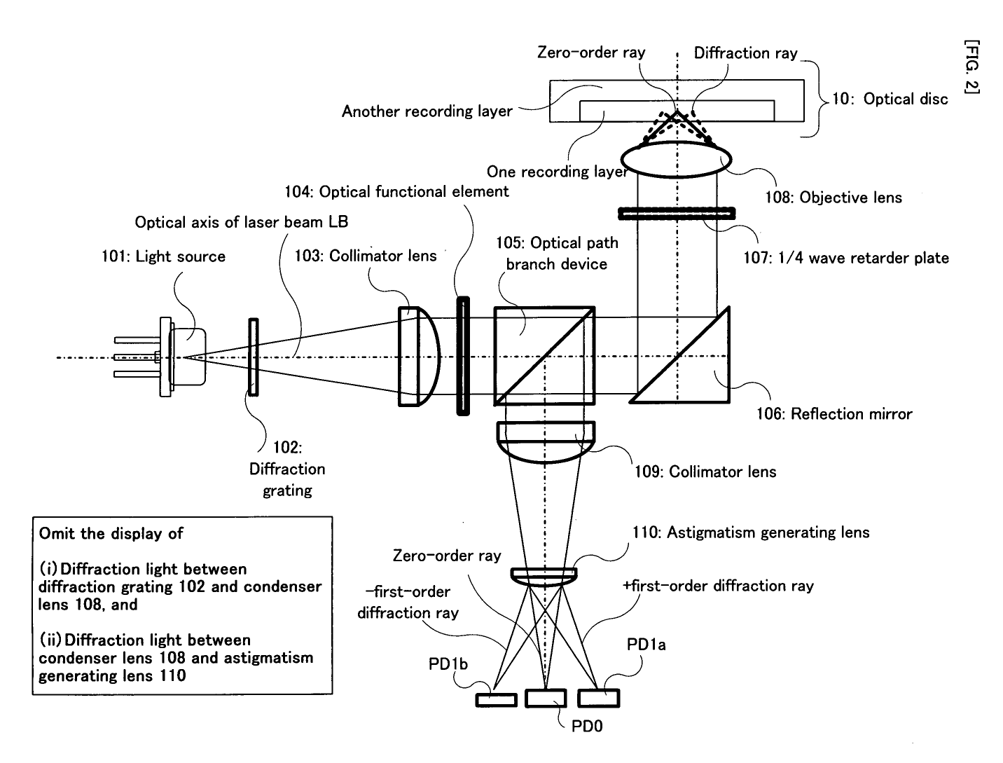

Next, with reference to FIG. 2, an explanation will be given on the more detailed structure of the optical pickup 100 provided for the information recording/reproducing apparatus 300 in the embodiment. FIG. 2 is a block diagram conceptually showing the more detailed structure of the optical pickup 100 provided for the information recording/reproducing apparatus 300 in the embodiment.

As shown in FIG. 2, the optical pickup 100 is provided with: a semiconductor laser 101; a diffraction grating 102; a collimator lens or a condenser lens 103; an optical functional element 104; an optical path branch element 105; a reflection mirror 106; a ¼ wave retarder plate or a ¼ wavelength plate 107; an objective lens or a condenser lens 108; a collimator lens or a condenser lens 109; an astigmatism generating lens 110; a light receiving device (or photo detector) PD0; a light receiving device (or photo detector) PD1a; and a light receiving device (or photo detector) PD1b. Therefore, a laser beam LB is emitted from the semiconductor laser 101 in the following order and is received by the light receiving device PD0 or the like through each element. That is, if it is guided to one recording layer of the optical disc as a so-called outward on the optical path, the laser beam LB emitted from the semiconductor laser 101 is guided to the one recording layer through the diffraction grating 102, the collimator lens or the condenser lens 103, the optical functional element 104, the optical path branch element 105, the reflection mirror 106, the ¼ wave retarder plate or the ¼ wavelength plate 107, and the objective lens or the condenser lens 108. On the other hand, as a so-called homeward on the optical disc, the laser beam LB reflected by the one recording layer is received on the light receiving device PD0 through the objective lens or the condenser lens 108, the ¼ wavelength plate 107, the reflection mirror 106, the optical path branch element 105, the collimator lens or the condenser lens 109, and the astigmatism generating lens 110.

In particular, the display of the diffraction light generated on the diffraction grating 102 is omitted on the optical path between the diffraction grating 102 and the objective lens or the condenser lens 108. Moreover, substantially in the same manner, the display of the diffraction light is also omitted on the optical path between the condenser lens 108 and the astigmatism generating lens 110.

Incidentally, the condenser lenses 103, 108, and 109, the optical path branch element 105, the reflection mirror 106, the ¼ wavelength plate 107, and the astigmatism generating lens 110 constitute one specific example of the optical system of the present invention. Moreover, the light receiving devices PD0, PD1a, and PD1b constitute one specific example of the light receiving device of the present invention.

The semiconductor laser 101 emits the laser beam LB in an elliptical light emission pattern which enlarges more in a perpendicular direction than in a horizontal direction, for example.

The diffraction grating 102 diffracts the laser beam emitted from the semiconductor laser 101, to zero-order light (or zero-order ray), +first-order light (or plus first-order ray), and −first-order light (or minus first-order ray).

The condenser lens 103 makes the incident laser beam LB substantially parallel and makes it enter the optical functional element 104.

The optical functional element 104 differentiates the polarization direction of the zero-order light (or the zero-order ray) and the polarization directions of the ±first-order lights (or the ±first-order rays), which are components of the incident laser beam LB. Incidentally, the optical functional element 104 will be detailed later. Moreover, as one specific example of the optical functional element 104, a phase difference film can be listed.

The optical path branch element 105 is an optical element for branching the optical path on the basis of the polarization direction, such as a beam splitter. Specifically, the optical path branch element 105 transmits the laser beam LB whose polarization direction is one direction therethrough in such a condition that there is little or no loss of the quantity of light, and reflects the laser beam LB which enters from the optical disc side and whose polarization direction is another direction in such a condition that there is little or no loss of the quantity of light. The reflected light reflected on the optical path branch element 105 is received by the light receiving devices PD0, PD1a, and PD1b, through the condenser lens 109 and the astigmatism generating lens 110.

The reflection mirror reflects the laser beam LB in such a condition that there is little or no loss of the quantity of light.

The ¼ wavelength plate 107 provides the laser beam with a phase difference of 90 degrees, to thereby convert the linearly-polarized laser beam to circularly-polarized light and convert the circularly-polarized laser to the linearly-polarized laser.

The condenser lens 108 focus the incident laser beam LB and irradiates it on the recording surface of the optical disc 10. Specifically, the condenser lens 108 is provided, for example, with an actuator device, and has a driving mechanism for changing the arrangement position of the condenser lens 108. More specifically, the actuator device displaces the position of the condenser lens 108, e.g. the objective lens, in a focus direction, to thereby focus a focal point on one recording layer and another recording layer of the optical disc.

The condenser lens 109 focuses the reflected light reflected on the optical path branch element 105.

The light receiving device PD0 receives the zero-order light (or the zero-order ray). The light receiving device PD1a receives the +first-order light (or +first-order ray). The light receiving device PD1b receives the −first-order light (or −first-order ray).

(3) Optical Functional Element

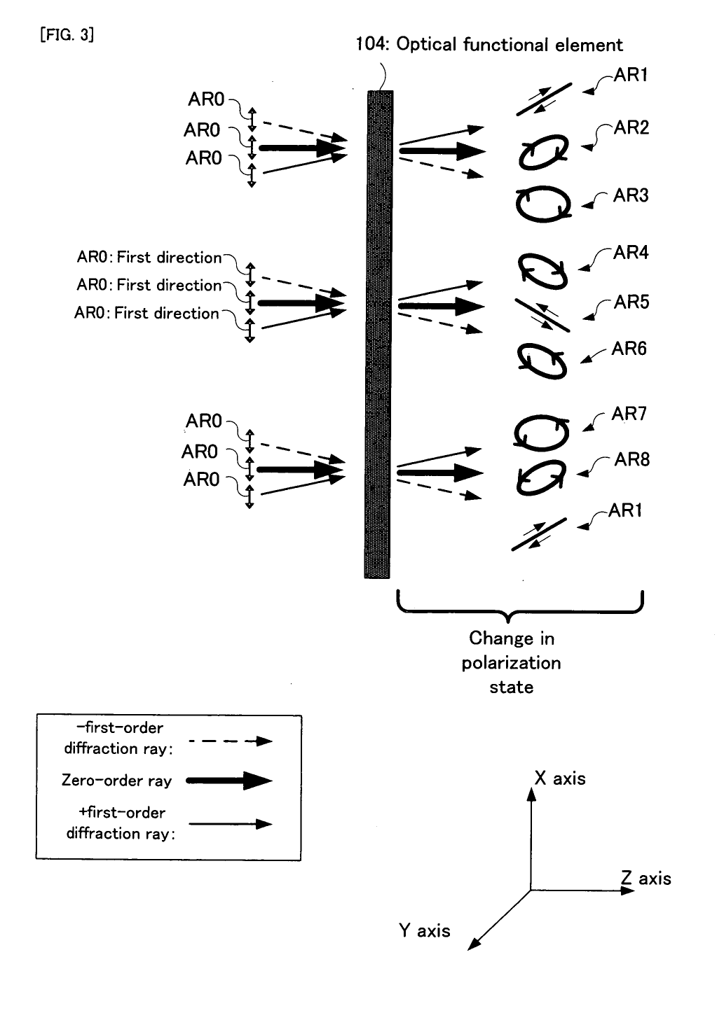

Next, with reference to FIG. 3 to FIG. 7, an explanation will be given on the optical principle of the optical functional element 104 in the embodiment.

(3-1) Optical Functional Element Which Changes Predetermined Polarization State

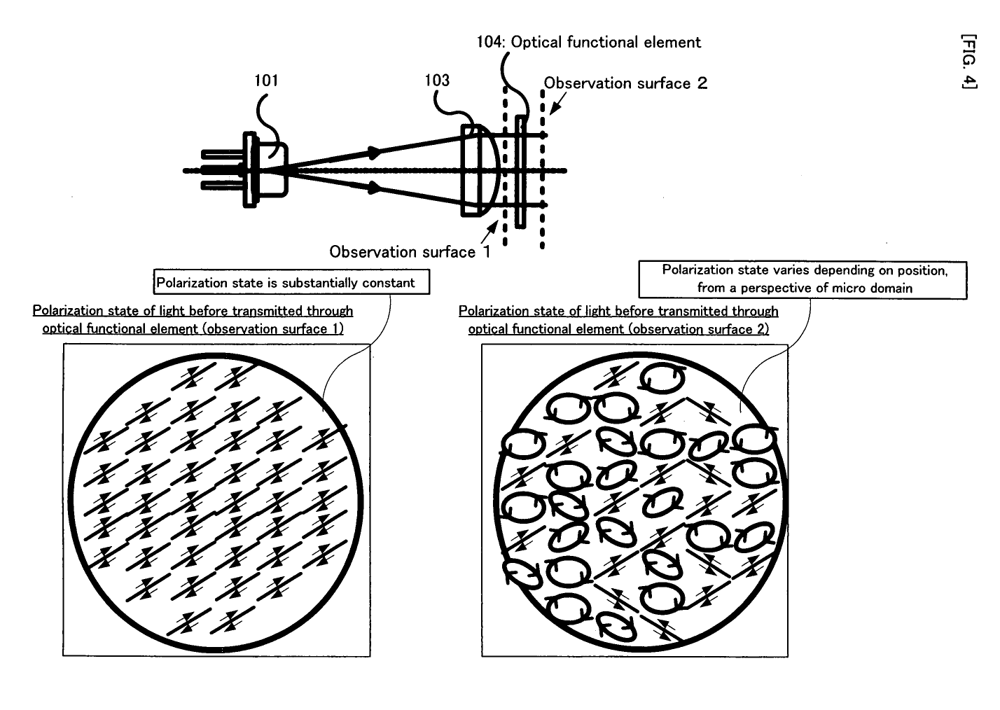

Next, with reference to FIG. 3 and FIG. 4, an explanation will be given on the optical principle of the optical functional element which changes the predetermined polarization state. FIG. 3 is a cross sectional view conceptually showing the optical principle of the optical functional element 104 in the embodiment, with a focus on an X-axis direction and a Z-axis direction. FIG. 4 is a cross sectional view schematically showing the optical placement or position of the optical functional element in the embodiment and the polarization state of a light flux of a laser beam before and after being transmitted through the optical functional element. Incidentally, the polarization state in FIG. 4 schematically indicates that it is oscillating parallel to a paper surface, with respect to the travelling direction of the light, which is perpendicular to the paper surface.

As shown in FIG. 3, the optical functional element 104 in the embodiment can change a predetermined polarization state having a constant polarization direction of the laser beam, such as the zero-order light or the ±first-order diffraction lights or plus/minus first-order diffraction lights (i.e. −first-order light in addition to or instead of +first-order light), which are transmitted through the optical functional element 104, by a unit of micro domain of the optical functional element, in each position of the micro domain. Here, the “micro domain” in the embodiment means a predetermined area of the optical functional element, in order to differentiate the extent of changing the predetermined polarization state of the laser beam, in each position.

Specifically, all the polarization direction of the zero-order light or the polarization directions of the ±first-order diffraction lights are first directions (refer to arrows AR0 in FIG. 3: e.g. a parallel direction to the paper surface), before they enter the optical functional element 104, in other words, before the laser beam is transmitted through the optical functional element 104. After the laser beam is transmitted through the optical functional element 104, the polarization state of the laser beam, such as the zero-order light, is different from before entering, and the polarization state of the laser beam is changed to a plurality of types of polarization states (e.g. refer to arrows AR1 to AR8 in FIG. 3).

Specifically, according to the study by the present inventors, as shown in the left part of FIG. 4, the polarization state of the light flux of the laser beam before transmitted through the optical functional element 104, i.e. in an observation surface “1”, is a polarization state of linear polarization, for example, having a constant polarization direction. On the other hand, as shown in the right part of FIG. 4, the polarization state of the light flux of the laser beam after the laser beam is transmitted through the optical functional element 104, i.e. in an observation surface “2”, is such a polarization state that linear polarization or elliptic polarization are mixed, for example. More specifically, if (i) the laser beam in which the predetermined polarization state is changed by the unit of micro domain included in the irradiation area of the optical functional element, in each position of the micro domain, and (ii) natural light that one sees on a daily basis, such as sunlight or lamplight, are compared, the natural light does not maintain the predetermined polarization state, i.e. a predetermined oscillation state or vibrational state in an electric field nor a predetermined oscillation state in a magnetic field. In addition, the natural light does not maintain the predetermined polarization state, i.e. the predetermined oscillation state in the electric field or the magnetic field, even in terms of time.

In contrast, the laser beam in which the predetermined polarization state is changed by the unit of micro domain included in the irradiation area of the optical functional element, in each position of the micro domain, maintains the constant polarization state, i.e. the constant oscillation state in the electric field or magnetic field, as a unit of small portion of the laser beam. In other words, with regard to the laser beam in which the predetermined polarization state is changed by the unit of micro domain included in the irradiation area of the optical functional element, in each position of the micro domain, the small portion of the laser beam maintains the constant polarization state on a micro basis. And all the constant polarization states maintained by the small portions of the laser beam almost or completely vary in each position. In addition, with regard to the laser beam in which the predetermined polarization state is changed by the unit of micro domain included in the irradiation area of the optical functional element, in each position of the micro domain, there are the laser beams in various types of polarization states mixed on a macro basis, so that it can be said that the laser beam does not maintain a uniform polarization state.

As a result, after the light or the laser beam is transmitted through the optical functional element 104, the predetermined polarization state of the zero-order light is changed by the unit of micro domain of the optical functional element in each position of the micro domain. At the same time, the predetermined polarization states of the ±first-order diffraction lights can be changed by the unit of micro domain of the optical functional element in each position of the micro domain. Therefore, it is possible to effectively reduce an influence of light interference between the stray light of the zero-order light and the signal lights of the ±first-order diffraction lights, whose irradiation areas overlap, on the light receiving devices. In particular, since the stray light of the zero-order light and the signal lights of the ±first-order diffraction lights have substantially the same level of light intensity, it is possible to more significantly reduce the influence of the light interference by the stray light on the light receiving device PD1a (or PD1b) which receives the ±first-order diffraction lights, by differentiating the polarization directions or the polarization states. In addition, even in the signal light of the zero-order light and the stray lights of the ±first-order diffraction lights, it is possible to reduce the influence of the light interference by the stray light on the light receiving device PD0 which receives the zero-order diffraction lights, by differentiating the polarization directions or the polarization states.

As a result, it is possible to make the light receiving device receive the light, under the condition that the influence of the stray light is effectively reduced and the level of the light intensity is maintained to be higher, for example, in the tracking control based on a three-beam method on the multilayer type information recording medium, to thereby achieve the highly-accurate tracking control.

(3-2) One Pattern of a Plurality Types of Polarization States Changed From Predetermined Polarization State

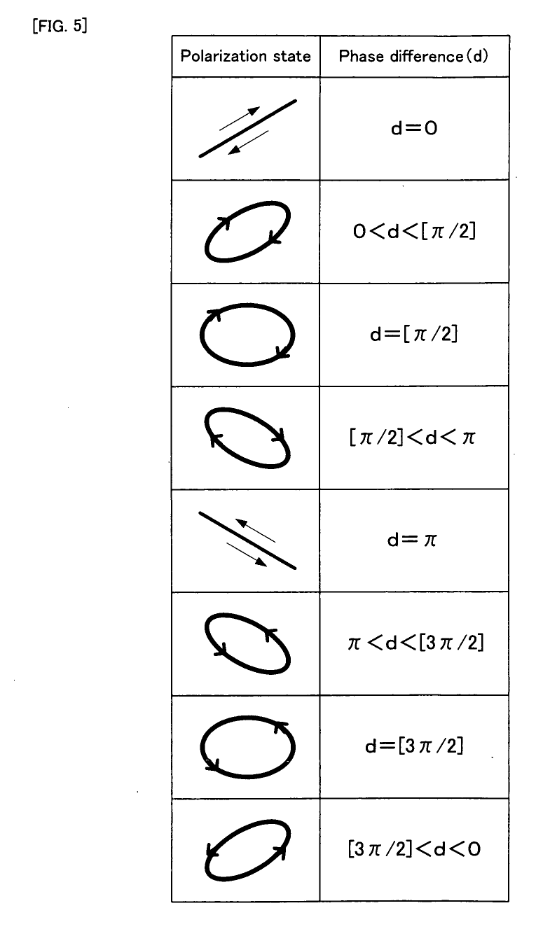

Now, with reference to FIG. 5, an explanation will be given on a pattern of polarization states changed from the predetermined polarization state by the unit of micro domain of the optical functional element in each position of the micro domain, in the embodiment, i.e. a pattern of a plurality of types of polarization states, such as linear polarization or elliptic polarization. FIG. 5 is a table showing a pattern of the polarization state in the embodiment. Incidentally, the pattern of the polarization state in FIG. 5 is classified into, but not limited to, eight, for convenience of explanation. Moreover, the actual polarization state is unrelated to the classification and can be continuously changed. Moreover, the polarization state in FIG. 5 schematically indicates that it is oscillating parallel to the paper surface, with respect to the travelling direction of the light, which is perpendicular to the paper surface.

As shown in FIG. 5, in general, it is possible to classify the polarization state of the laser beam into eight typical states, for example. In other words, generally, the polarization state can be decomposed into two linear polarization components which oscillate in directions crossing each other at a right angle in a plane perpendicular to the traveling direction of the light. Therefore, the polarization state of the laser beam can be broadly classified into linear polarization, elliptic polarization, and circular polarization, on the basis of the amplitude and the phase difference of the two linear polarization components.

Specifically, as shown in FIG. 5, if a phase difference “d” of the two linear polarization components is “0”, the polarization state of the laser beam is, for example, linear polarization which oscillates in a diagonally right upward direction. Moreover, if the phase difference “d” of the two linear polarization components is greater than “0” and less than “π/2”, the polarization state of the laser beam is, for example, elliptic polarization which oscillates clockwise and which has a long axis in the diagonally right upward direction. Moreover, if the phase difference “d” of the two linear polarization components is “π/2”, the polarization state of the laser beam is, for example, elliptic polarization which oscillates clockwise and which has a long axis in a lateral direction. Moreover, if the phase difference “d” of the two linear polarization components is greater than “π/2” and less than “π”, the polarization state of the laser beam is, for example, elliptic polarization which oscillates clockwise and which has a long axis in a diagonally left upward direction.

Then, if the phase difference “d” of the two linear polarization components is “π”, the polarization state of the laser beam is, for example, linear polarization which oscillates in the diagonally left upward direction. Moreover, if the phase difference “d” of the two linear polarization components is greater than “π” and less than “3π/2”, the polarization state of the laser beam is, for example, elliptic polarization which oscillates counterclockwise and which has a long axis in the diagonally left upward direction. Moreover, if the phase difference “d” of the two linear polarization components is “3π/2”, the polarization state of the laser beam is, for example, elliptic polarization which oscillates counterclockwise and which has a long axis in the lateral direction. Moreover, if the phase difference “d” of the two linear polarization components is greater than “3π/2” and less than “2π”, the polarization state of the laser beam is, for example, elliptic polarization which oscillates counterclockwise and which has a long axis in the diagonally right upward direction.

(4) Study of Operation and Effect in Embodiment

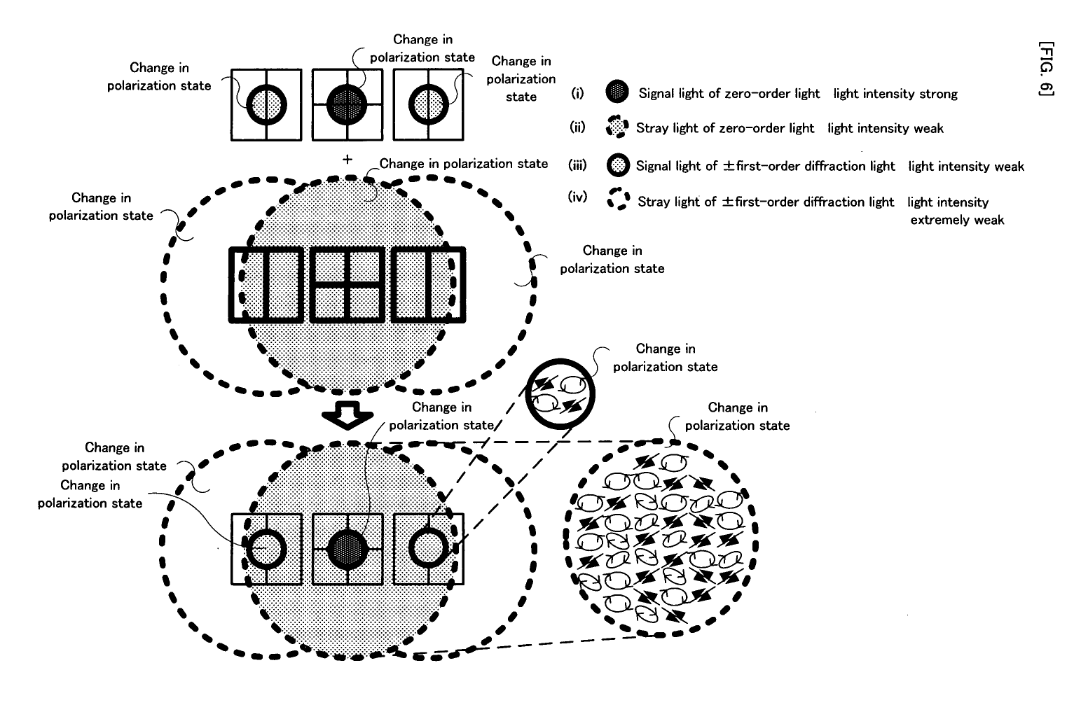

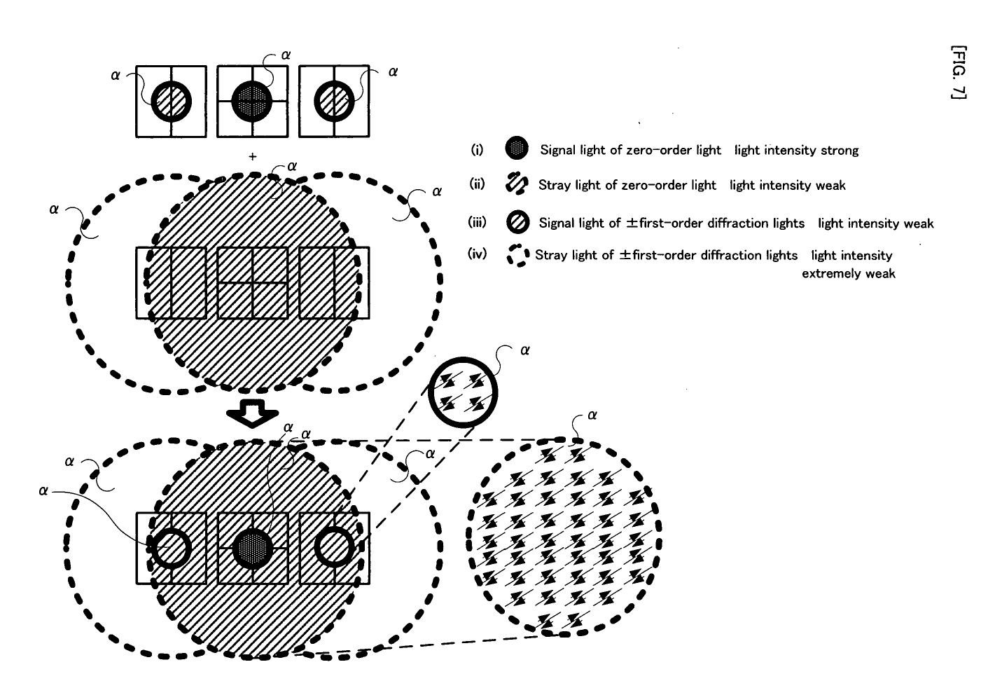

Next, with reference to FIG. 6 and FIG. 7, the operation and effect in the embodiment will be considered. FIG. 6 is a plan view conceptually showing a relative positional relationship among optical diameters of the zero-order light and the ±first-order diffraction lights irradiated on three light receiving devices in the embodiment. FIG. 7 is a plan view conceptually showing a relative positional relationship among optical diameters of the zero-order light and the ±first-order diffraction lights irradiated on three light receiving devices in a comparison example. Incidentally, in FIG. 6 and FIG. 7, with regard to the areas irradiated with the light, conceptually, there are the following four types of areas. That is, the areas are (i) an area which is irradiated with the signal light of the zero-order light and which has the highest level of the light intensity per unit area (i.e. an area with the maximum level of the light intensity), (ii) an area which is irradiated with the stray light of the zero-order light and which has the second highest level of the light intensity per unit area, (iii) an area which is irradiated with the signal lights of the ±first-order diffraction lights and which has the second highest level of the light intensity per unit area, and (iv) an area which is irradiated with the stray lights of the ±first-order diffraction lights and which has the third highest level of the light intensity per unit area (i.e. an area with the minimum level of the light intensity). Incidentally, the intensity per unit area in the aforementioned area of (ii) type also depends on optical path designing, such as size of the irradiation area. Thus, although the level of the light intensity in the area of (ii) type and the level of the light intensity in the area of (iii) type are the same “second”, they do not necessarily match. Here, note that the expression “second” is used in order to express the relative light intensity level from the area of (i) type to the area of (iv) type.

As shown in an upper part of FIG. 6, after the light or the laser beam is transmitted through the optical functional element 104, the predetermined polarization state of the zero-order light is changed by the unit of micro domain of the optical functional element in each position of the micro domain, on the optical pickup in the embodiment. At the same time, the predetermined polarization states of the ±first-order diffraction lights can be changed by the unit of micro domain of the optical functional element in each position of the micro domain. Then, since the size and the central position of the irradiation area varies between the zero-order light and the ±first-order diffraction lights on the light receiving devices which receives the zero-order light and the ±first-order diffraction lights, it is possible to reduce the light interference between (i) the zero-order light in which the predetermined polarization state is changed by the unit of micro domain in each position of the micro domain and (ii) the ±first-order diffraction lights in which the predetermined polarization states are changed by the unit of micro domain in each position of the micro domain.

In particular, as shown in a central part of FIG. 6, since the stray light of the zero-order light and the signal lights of the ±first-order diffraction lights have substantially the same level of the light intensity, it is possible to more significantly reduce the influence of the light interference by the stray light on the light receiving device PD1a (or PD1b) which receives the ±first-order diffraction lights, as shown in a lower part of FIG. 6, by differentiating the polarization directions or the polarization states. In addition, even in the signal light of the zero-order light and the stray lights of the ±first-order diffraction lights, it is possible to reduce the influence of the light interference by the stray light on the light receiving device PD0 which receives the zero-order lights, by differentiating the polarization directions or the polarization states.

If the predetermined polarization state of the zero-order light is not changed by the unit of micro domain of the optical functional element in each position of the micro domain, or if the predetermined polarization states of the ±first-order diffraction lights are not changed by the unit of micro domain of the optical functional element in each position of the micro domain, as shown in a lower part of FIG. 7, since the stray light of the zero-order light and the signal lights of the ±first-order diffraction lights have substantially the same polarization state (refer to the polarization direction in angle “α” in FIG. 7) and have substantially the same level of the light intensity, the influence of the light interference by the stray light increases on the light receiving device PD1a (or PD1b) which receives the ±first-order diffraction lights, and thus it is hard to properly perform the tracking control.

In contrast, according to the embodiment, after the light or the laser beam is transmitted through the optical functional element 104, the predetermined polarization state of the zero-order light is changed by the unit of micro domain of the optical functional element in each position of the micro domain. At the same time, the predetermined polarization states of the ±first-order diffraction lights can be changed by the unit of micro domain of the optical functional element in each position of the micro domain. As a result, it is possible to make the light receiving device receive the light, under the condition that the influence of the stray light is effectively reduced and the level of the light intensity is maintained to be higher, for example, in the tracking control based on the three-beam method on the multilayer type information recording medium, to thereby achieve the highly-accurate tracking control.

(5) Specific embodiment of optical functional element

(5-1) One Specific Embodiment of Optical Functional Element (ver. 1)

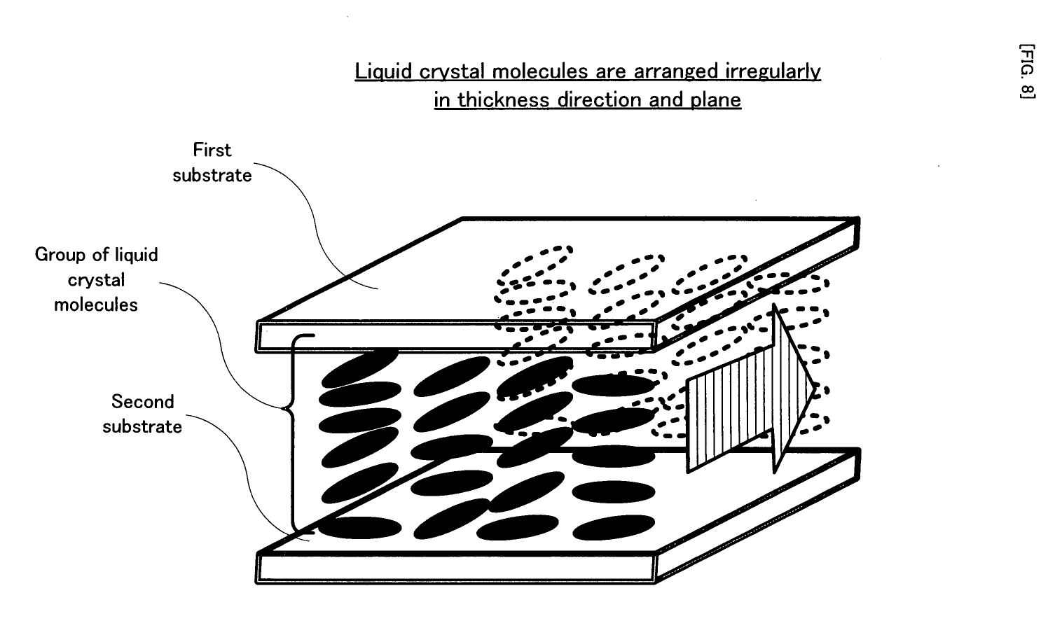

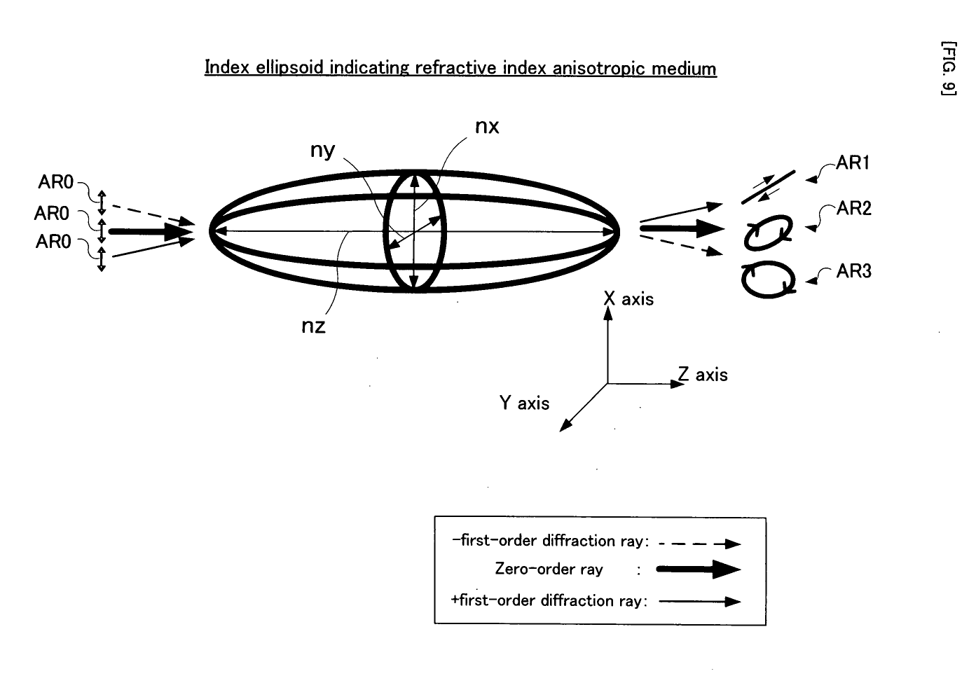

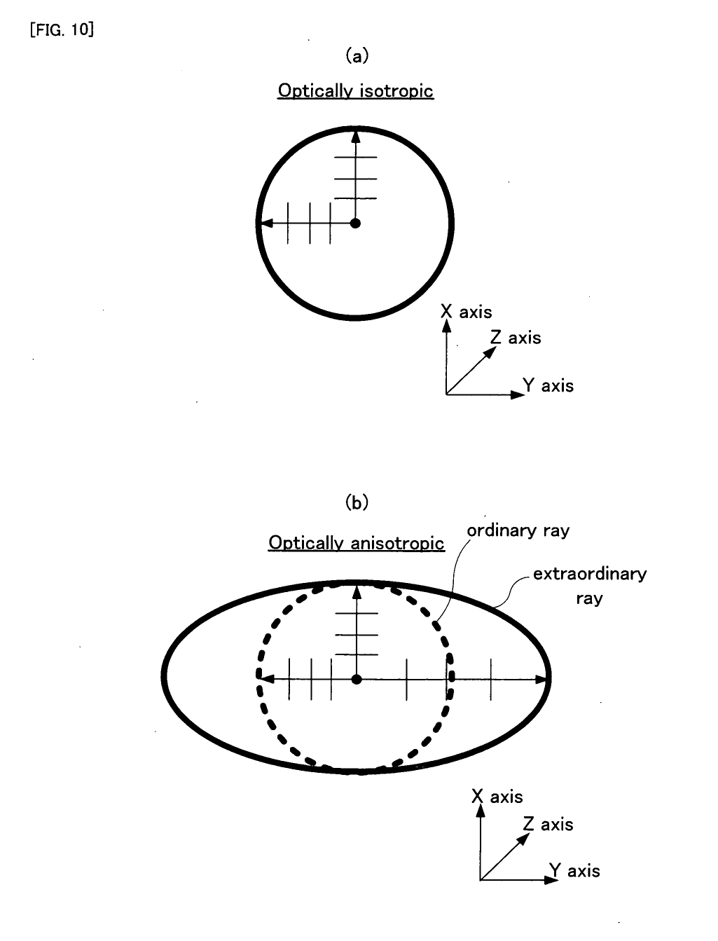

Next, with reference to FIG. 8 to FIGS. 10, an explanation will be given on one specific example (ver. 1) of the optical functional element 104 in the embodiment. FIG. 8 is a schematic diagram conceptually showing a positional relationship among (i) a first substrate, (ii) liquid crystal molecules, and (iii) a second substrate, which constitute the optical functional element 104 in the embodiment. FIG. 9 is a schematic diagram conceptually showing an optically anisotropic medium (i.e. medium with anisotropic of refractive index or refractive index anisotropic medium) which constitutes the optical functional element 104 in the embodiment. FIG. 10 are a schematic diagram conceptually showing a general optically isotropic nature (FIG. 10(a)) and a schematic diagram conceptually showing general optical anisotropy (FIG. 10(b)). Incidentally, the scale on the line of an arrow in FIG. 10, indicates the length of the optical path per unit time. In particular, as one specific example of the first substrate and the second substrate, an oriented film can be listed.

As shown in FIG. 8, one specific example of the optical functional element 104 in the embodiment, is provided with (i) the first substrate, (ii) the second substrate, and (iii) the liquid crystal molecules (i.e. one specific example of the “refractive index anisotropic medium” or the “medium with anisotropic of refractive index” of the present invention) enclosed between the first substrate and the second substrate. Here, the “refractive index anisotropic medium” or the “medium with anisotropic of refractive index” in the embodiment means a medium with optical anisotropy (hereinafter referred to as a “refractive index anisotropic medium” or “index ellipsoid” or “refractive index ellipsoidal body”, as occasion demands). In particular, the liquid crystal molecules are enclosed between the first substrate and the second substrate, with them irregularly arranged in at least one of a thickness direction and a plane direction. More specifically, in order to realize one specific example of the optical functional element 104 in the embodiment, for example, a process of rubbing the aforementioned oriented film with a cloth, i.e. a rubbing process, may not be performed on a liquid crystal element of a general liquid crystal apparatus.

Specifically, an index ellipsoid or a refractive index ellipsoidal body of the liquid crystal molecules which constitute the optical functional element 104 has the optical property shown in FIG. 9. In general, when the optical property, such as the refractive index of a material, is expressed, it is easy to understand it if considering components (nx, ny, nz) obtained by decomposition based on three orthogonal coordinate axes. As a result of the decomposition of the component, if all the three values based on the three coordinate axes are equal, then it can be said that this material is isotropic. In other words, as shown in FIG. 10(a), the speed in the isotropic medium in an ordinary ray (or a normal light beam) is equal to the speed in the isotropic medium in an extraordinary ray (or an abnormal light beam) on the basis of birefringence, so that there is no phase difference between the phase of the normal light beam and the phase of the abnormal light beam after the light beams are transmitted through the isotopic medium.

In contrast, in the liquid crystal molecules which constitute the optical functional element 104, as shown in FIG. 9, for example, if the value of the x-axis component is equal to the value of the y-axis component, (i) the light coming from the z-axis direction and (ii) the light coming from a direction deviating from the z-axis direction have different amount of phase difference of the polarization received or affected by the incident lights. In other words, as shown in FIG. 10(b), the speed in the liquid crystal molecules enclosed in the optical functional element 104 in the ordinary ray or the normal light beam, is different from the speed in the liquid crystal molecules in the extraordinary ray or the abnormal light beam on the basis of birefringence, so that there is a phase difference of “0 degree” to “2π”, as described above, between the phase of the normal light beam and the phase of the abnormal light beam, after the light beams are transmitted through the optical functional element 104. Therefore, after the laser beam is transmitted through the optical functional element 104, the polarization state of the laser beam is different from before entering and is changed to a random polarization state.

As a result, after the light is transmitted through one specific example of the optical functional element 104 formed of or constituted from the liquid crystal molecules which are irregularly arranged in at least one of the thickness direction and the plane direction, the predetermined polarization state of the zero-order light is changed by the unit of micro domain of the optical functional element in each position of the micro domain. At the same time, the predetermined polarization states of the ±first-order diffraction lights can be changed by the unit of micro domain of the optical functional element in each position of the micro domain.

In addition, as a result, in one specific example of the optical functional element 104, for example, it is possible to reduce the degree of influence of wavelength dependence, compared to the optical element for controlling the phase difference, such as a phase difference film. Specifically, with regard to the laser beam in which the predetermined polarization state is changed by the unit of micro domain included in the irradiation area of the optical functional element in each position of the micro domain, various phase difference are randomly applied to the small portions of the laser beam on a micro basis. Therefore, there are the laser beams in various types of polarization states mixed on a macro basis, so that the laser beam hardly maintains or does not maintain at all the wavelength dependence.

Moreover, in addition, as a result, in one specific example of the optical functional element 104, a voltage application is not performed in a general liquid crystal display. Thus, it is possible to set the thickness (i.e. film thickness) of a layer between the first substrate and the second substrate in which the liquid crystal molecules are enclosed, to a predetermined thickness (e.g. to be thicker) in which the degree of freedom of space is higher than the general liquid crystal display. In particular, the predetermined thickness can be determined on the basis of the degree of changing the predetermined polarization state in each small portion of the laser beam by the unit of micro domain of the optical functional element in each position of the micro domain.

Moreover, in addition, as a result, in one specific example of the optical functional element 104, light transmittance can be increased, compared to the case where a general diffuser plate is combined with the aforementioned phase difference film or the like. Thus, it is possible to reduce a loss in the amount of light. Here, the diffuser plate in the embodiment is an optical element, which changes a spatial distribution of light because the electromagnetic wave of light spreads due to irregularity on a material surface or optical inhomogeneity of a medium.

(5-2) Another Specific Embodiment of Optical Functional Element (ver. 2)

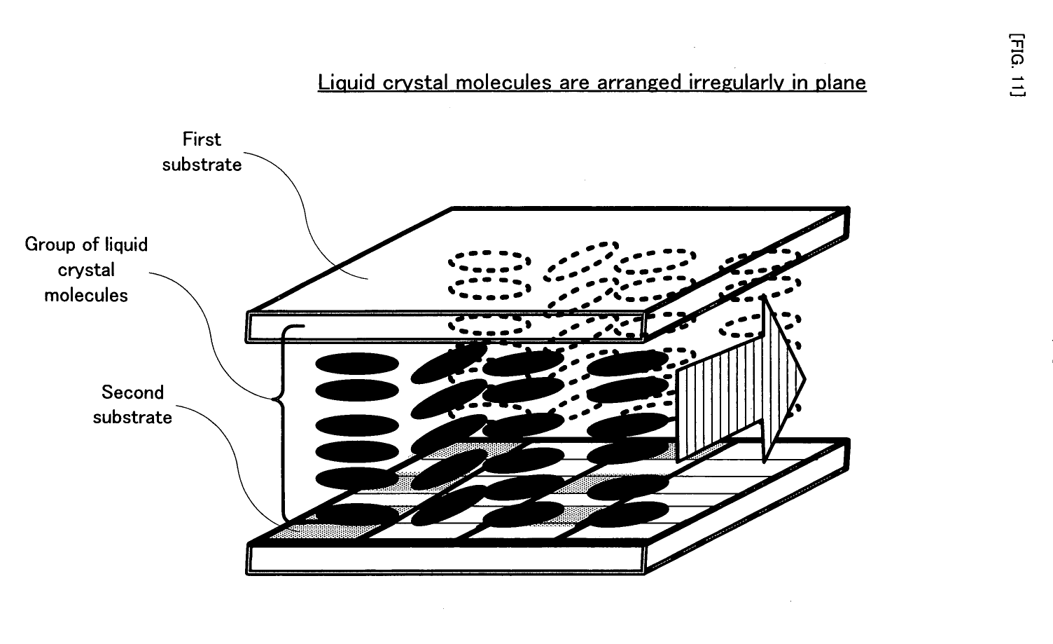

Next, with reference to FIG. 11, an explanation will be given on another specific example (ver. 2) of the optical functional element 104 in the embodiment. FIG. 11 is a schematic diagram conceptually showing another positional relationship among (i) a first substrate, (ii) liquid crystal molecules, and (iii) a second substrate, which constitute the optical functional element 104 in the embodiment. Incidentally, a square on the second substrate (and a not-illustrated square on the first substrate) indicates a conceptual difference (or irregularity) in the process of rubbing the oriented film. On the basis of the difference (or irregularity) in the process of rubbing the oriented film, an assembly of the liquid crystal molecules in the embodiment, may be defined.

As shown in FIG. 11, another specific example (ver. 2) of the optical functional element 104 in the embodiment is provided with (i) the first substrate, (ii) the second substrate, and (iii) the liquid crystal molecules enclosed between the first substrate and the second substrate. In particular, the liquid crystal molecules are enclosed between the first substrate and the second substrate with them irregularly arranged in the plane direction. Specifically, the liquid crystal molecules are arranged in the normal direction of the first substrate and the second substrate, with the long axis directions of the liquid crystal molecules inclined at substantially the same angle. On the other hand, in the plane direction of the first substrate and the second substrate, the liquid crystal molecules are arranged irregularly, with the long axis directions of the liquid crystal molecules differing from each other.

As a result, in another specific example of the optical functional element 104 in the embodiment, after the light or the laser beam is transmitted through another specific example of the optical functional element 104 formed of or constituted from the liquid crystal molecules which are irregularly arranged in the plane direction, the predetermined polarization state of the zero-order light is changed by the unit of micro domain of the optical functional element in each position of the micro domain. At the same time, the predetermined polarization states of the ±first-order diffraction lights can be changed by the unit of micro domain of the optical functional element in each position of the micro domain.

In addition, as a result, in another specific example of the optical functional element 104, for example, it is possible to determine the degree of changing the predetermined polarization state in each small portion of the laser beam by the unit of micro domain of the optical functional element in each position of the micro domain, with higher accuracy, on the basis of the liquid crystal molecules which are arranged with their long axis directions inclined at substantially the same angle, in the normal direction of the first substrate and the second substrate.

(5-3) Another embodiment of optical pickup

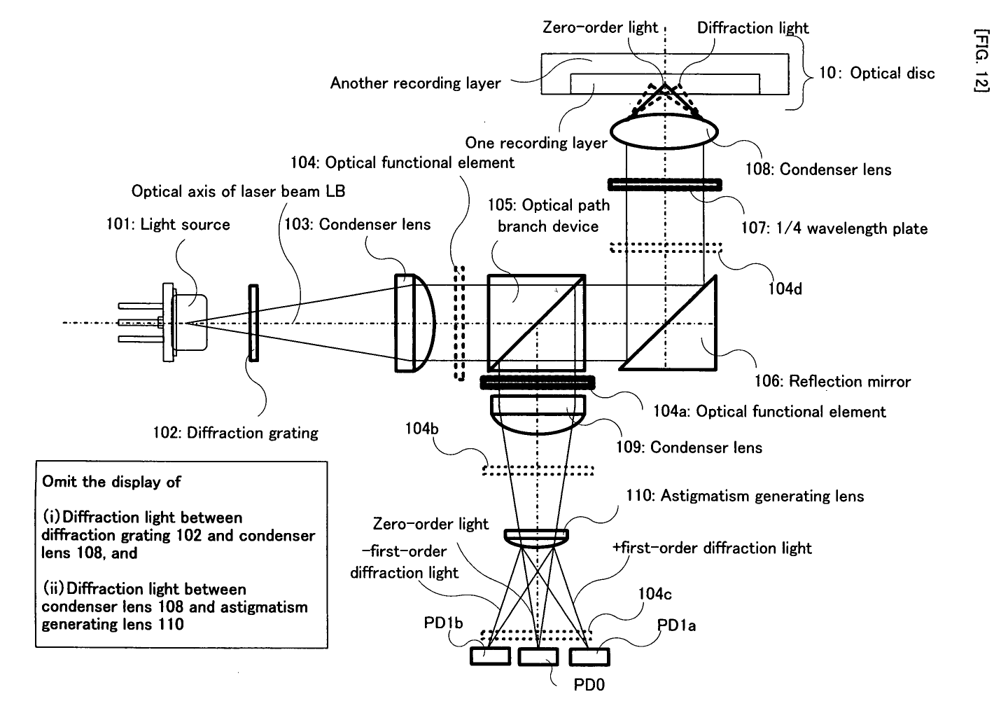

Next, with reference to FIG. 12, an explanation will be given on the structure of the optical pickup 100 provided for the information recording/reproducing apparatus 300 in another embodiment. Incidentally, in another embodiment, substantially the same constituent elements as those in the embodiment explained in FIG. 1 to FIG. 11 described above, carry the same numerical references, and the explanation thereof will be omitted, as occasion demands. FIG. 12 is a block diagram conceptually showing the more detailed structure of an optical pickup 100 provided for an information recording/reproducing apparatus 300 in another embodiment.

In particular, substantially in the same manner as described above the display of the diffraction light generated on the diffraction grating 102 is omitted on the optical path between the diffraction grating 102 and the condenser lens 108. Moreover, substantially in the same manner as described above, the display of the diffraction light is also omitted on the optical path between the condenser lens 108 and the astigmatism generating lens 110.

As shown in FIG. 12, the optical pickup 100 in another embodiment is provided with: an optical functional element 104a instead of the optical functional element 104, on the optical path between the optical path branch element 105 and the condenser lens 109. That is, (i) an operation of changing the predetermined polarization state of the zero-order light by the unit of micro domain of the optical functional element in each position of the micro domain, and (ii) an operation of changing the predetermined polarization states of the ±first-order diffraction lights by the unit of micro domain of the optical functional element in each position of the micro domain, by virtue of the optical functional element 104a, are performed on a parallel light flux between the optical path branch element and the condenser lens 109.

Alternatively, the optical pickup 100 in another embodiment may be provided with: an optical functional element 104c instead of the optical functional element 104, on the optical path immediately before the irradiation onto the light receiving devices PD0, PD1a, and PD1b.

Alternatively, the optical pickup 100 in another embodiment may be provided with: an optical functional element 104d instead of the optical functional element 104, on the optical path between the reflection mirror 106 and the ¼ wavelength plate 107.

Consequently, it is possible to efficiently reduce a loss in the amount of light with respect to the zero-order light and a loss in the amount of light with respect to the diffraction light, on the basis of the position on the optical path in which the optical functional element is disposed (i.e. the optical functional elements 104a, 104b, 104c, and 104d).

The present invention is not limited to the aforementioned embodiments, but various changes may be made, if desired, without departing from the essence or spirit of the invention which can be read from the claims and the entire specification. An optical pickup and information equipment, all of which involve such changes, are also intended to be within the technical scope of the present invention.

### INDUSTRIAL APPLICABILITY

The optical pickup and the information equipment of the present invention can be applied to an optical pickup for irradiating an information recording medium, such as a DVD, with a laser beam when an information signal is recorded or reproduced, and information equipment provided with the optical pickup.

1. An optical pickup for recording or reproducing an information signal with respect to an optical disc comprising a plurality of recording layers, each recording layer having a recording track in which information pits are arranged, the information signal being recorded in the information pits, said optical pickup comprising:
a light source for irradiating a laser beam;
an optical system for guiding the laser beam to one recording layer of the plurality of recording layers;
an optical functional element for changing a predetermined polarization state of the laser beam, by a unit of micro domain included in an area irradiated with the laser beam, in each position of the micro domain; and
one or a plurality of light receiving devices for receiving at least the laser beam.

2. The optical pickup according to claim 1, wherein the unit of micro domain is defined on the basis of magnitude of a constituent unit of a refractive index anisotropic medium, which constitutes said optical functional element.

3. The optical pickup according to claim 1, wherein the unit of micro domain is defined on the basis of magnitude of liquid crystal molecules, which constitute said optical functional element.

4. The optical pickup according to claim 1, wherein the unit of micro domain is defined on the basis of magnitude of an assembly of liquid crystal molecules defined by a difference in a process of rubbing an oriented film, which constitutes said optical functional element.

5. The optical pickup according to claim 1, wherein said optical functional element comprises: (i) a first substrate; (ii) a second substrate; and (iii) a refractive index anisotropic medium enclosed between the first substrate and the second substrate.

6. The optical pickup according to claim 1, wherein said optical functional element comprises: (i) a first substrate; (ii) a second substrate; and (iii) a refractive index anisotropic medium enclosed between the first substrate and the second substrate and arranged irregularly in at least one of a thickness direction and a plane direction.

7. The optical pickup according to claim 1, wherein said optical functional element is disposed on an optical path which is a parallel light flux.

8. The optical pickup according to claim 1, further comprising an optical path branching device for guiding the laser beam coming from the one recording layer, to said light receiving device.

9. The optical pickup according to claim 1, further comprising a diffracting device for diffracting the irradiated laser beam to zero-order light and diffraction light,
said optical system guiding the zero-order light and the diffraction light, which are diffracted, to the one recording layer,
said optical functional element (i) differentiating a polarization state in one portion of the zero-order light on the basis of all positions of the zero-order light and (ii) differentiating a polarization state in one portion of the diffraction light on the basis of all positions of the diffraction light,
said light receiving device receiving at least the diffraction light.

10. The optical pickup according to claim 9, further comprising an optical path branching device for guiding the zero-order light and the diffraction light coming from the one recording layer, to said light receiving device,
said optical functional element being disposed (i) on an optical path between said light source and said optical path branching device or (ii) on an optical path between said optical path branching device and said light receiving device.

11. The optical pickup according to claim 9, further comprising an optical path branching device for guiding the zero-order light and the diffraction light coming from the one recording layer, to said light receiving device,
said optical functional element being disposed (i) on an optical path, which is a parallel light flux, between said light source and said optical path branching device or (ii) on an optical path, which is a parallel light flux, between said optical path branching device and said light receiving device.

12. The optical pickup according to claim 9, wherein order of the diffraction light is ±first-order.

13. The optical pickup according to claim 1, comprising (i) a first light receiving device and (ii) a second light receiving device, which receive diffraction light of the laser beam, and (iii) a third light receiving device, which receives zero-order light of the laser beam, as said light receiving devices.

14. The optical pickup according to claim 1, further comprising a controlling device for controlling said optical system to guide the laser beam to the recording track provided for the one recording layer, on the basis of zero-order light and diffraction light of the laser beam.

15. An information equipment comprising:
an optical pickup; and
a recording/reproducing device for irradiating an optical disc with a laser beam, to thereby record or reproduce an information signal
said optical pickup is for recording or reproducing the information signal with respect to the optical disc comprising a plurality of recording layers, each recording layer having a recording track in which information pits are arranged, the information signal being recorded in the information pits, said optical pickup is comprising:
a light source for irradiating a laser beam;
an optical system for guiding the laser beam to one recording layer of the plurality of recording layers;
an optical functional element for changing a predetermined polarization state of the laser beam, by a unit of micro domain included in an area irradiated with the laser beam, in each position of the micro domain; and
one or a plurality of light receiving devices for receiving at least the laser beam.
